(19) United States
(12) Patent Application Publication
(10) Pub. No.: US 2026/0099965 A1
(43) Pub. Date: Apr. 9, 2026

(54) STIMULUS IMAGE GENERATION FOR MATHEMATICAL EDUCATION QUESTIONS USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Nima Shirazian, Palo Verdes Peninsula, CA (US); Pranav Kalyan, Agoura Hills, CA (US); Sean Carlson, Savage, MN (US); Simon Said, Malta (MT); Wesley Stander, Porto (PT); Minas Magdi, Alexandria (EG)

(73) Assignee: 2hr Learning, Inc., Austin, TX (US)

(21) Appl. No.: 19/352,376

(22) Filed: Oct. 7, 2025

Related U.S. Application Data
(60) Provisional application No. 63/704,537, filed on Oct. 7, 2024.

(51) Int. Cl. G06T 11/20; G06F 8/30; G09B 5/02; G09B 19/02

(52) U.S. Cl. CPC G06T 11/26; G06F 8/315; G09B 5/02; G09B 19/025

(57) ABSTRACT

A stimulus image generation system and method provide access to a data model containing educational standards and stimulus types, mapping educational standards to relevant stimulus types. The stimulus image generation system and method also offers access to a repository of JSON schemas and Python functions, linking stimulus types to specific JSON schemas and functions. Upon receiving an input query, the stimulus image generation system selects a relevant JSON schema and Python functions based on the stimulus type. The system then generates prompts to guide an AI engine in populating the chosen schema, incorporating inputs from the data model and query. The system transfers the prompts to the AI engine for schema population. A python function module then calls python functions to generate stimulus images, utilizing various rendering libraries.

### CROSS-REFERENCE TO RELATED APPLICATION(S)

This application claims the benefit under 35 U.S.C. § 119 (c) and 37 C.F.R. § 1.78 of U.S. Provisional Application No. 63/704,537, which is incorporated by reference in its entirety.

### FIELD OF THE INVENTION

The present invention relates in general to the field of electronics, and more specifically to a system and method for stimulus image generation for mathematical questions aligned with one or more educational standards.

### DESCRIPTION OF THE RELATED ART

Manual process of creating stimulus images by hand requires use of traditional media such as pencils and paints. While such a process provides personalized results, creating stimulus images manually is a time-consuming and laborious process especially when stimulus images are to be generated in bulk. The manual process of stimulus image creation is also inconsistent, and thereby scalability is another associated issue.

Template-based stimulus image generation tools are used traditionally, where specialized software generates stimulus images based on predefined templates or parameters. Users provide required input or specifications, and the template-based stimulus image generation tool creates stimulus images to meet such inputs or specifications of the users. Such template-based stimulus image generation tools have limited options for customization. Moreover, template-based stimulus image generation tools have rigid designs and often lack flexibility to incorporate unique or complex mathematical concepts.

Generic graphic design software, uses versatile programs like Adobe Photoshop to create or modify stimulus images digitally. These tools offer a wide range of features, allowing for complex manipulations and precise control over visual elements. The generic graphic design software requires design skills, without skills, the user will not be able to generate the stimulus images. Additionally, cost and efficiency are other constraints. The generic graphic design software are costly and will take time to generate a single design.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary stimulus image generation system to generate one or more stimulus for mathematical questions.

FIG. 2 depicts an exemplary stimulus image generation method to generate one or more stimulus for mathematical questions.

FIG. 3 depicts a flow for the stimulus image generation method, which is an embodiment of the stimulus image generation system of FIG. 2.

FIG. 4 depicts an exemplary network environment in which the stimulus image generation system of FIG. 1 and the stimulus image generation process of FIG. 2 may be practiced.

FIG. 5 depicts an exemplary computer system.

### DETAILED DESCRIPTION

The stimulus image generation system and method set forth herein address technical issues with generating one or more stimulus for mathematical questions described herein. Conventionally, manual processes were used to generate the one or more stimulus for mathematical questions and were very tedious and time consuming. The present stimulus image generation system and method utilize an automated system that does not merely automate a manual process or use a conventional system in a conventional way. The present stimulus image generation system and method utilize one or more artificial intelligence (AI) engines and integrate programmatic process management to technologically guide and constrain the one or more AI engines to produce the one or more stimulus for mathematical questions in a completely different way than both any manual process and different than normal use of programs and AI engines. Utilizing specially engineered guidance and control to direct an AI system in solving the technical problems presented below, which require a technical solution. The stimulus image generation system and method described below are not simply engaging a computer to carry out conventional mental processes, but rather change how computers (and AI systems, specifically) operate to achieve the generation results that were not previously possible or were substantially inefficient prior to the stimulus image generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the one or more stimulus for mathematical questions specified as produced by the stimulus image generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The stimulus image generation system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce the one or more stimulus for mathematical questions, perform quality control to retain or automatically discard outputs that do not meet guidance and constraints, and make the desired outputs available for use, such as use by computer system applications. In at least one embodiment, the problem to be solved by the integrated programmatic and AI engine stimulus image generation system and method is uniquely and unconventionally decomposed, and AI prompts are used to solve the decomposed problem. Furthermore, the programmatic inputs to the decomposed AI prompts provide guidance to generate one or more stimulus for mathematical questions.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the stimulus image generation system and method described herein. Thus, the present stimulus image generation system and method described implement an integration of programmatic management over decomposed prompts with engineered AI engine guidance and constraints to affect an improvement in AI, programmatic AI management, and AI integrated with programmatic management technology. The present stimulus image generation system and method allow computer systems to include programmatic management, one or more AI engines, and one or more data sources to produce theone or more stimulus for mathematical questions that previously could not be produced with conventionally prompted AI engines or could only be produced by humans utilizing a completely different, time consuming, and tedious process. The stimulus image generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:

1. Machine Learning Models-Algorithms that analyze data, recognize patterns, and make predictions.

2. Neural Networks-Deep learning architectures that mimic the human brain for tasks like image and speech recognition.

3. Data Processing Module-Handles raw data input, transformation, and feature extraction.

4. Inference Engine-Applies trained models to make real-time decisions based on new data.

5. Optimization Algorithms-Improves model efficiency, reducing errors and improving predictions.

6. Natural Language Processing (NLP) Module-Enables AI engines to understand, interpret, and generate human language (e.g., chatbots, voice assistants).

7. Computer Vision Module-Allows AI to interpret and analyze images or videos.

8. Reinforcement Learning Mechanism-Helps AI learn from trial and error, optimizing performance over time.

9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the stimulus image generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the stimulus image generation systems and methods and not to be construed as limiting of the embodiments of the stimulus image generation systems and methods described above.

An exemplary stimulus image generation system and stimulus image generation method generate one or more stimulus for mathematical questions. The stimulus image generation system uses a data model 106 that maps educational standards to stimulus types. A content generation system 108 receives data from the data model 106. A prompt generator 114 combines data from a JSON schema module 110 and input queries from an input database 104 to create prompts for generating stimulus descriptions. The content generation system 108 then sends these prompts to an AI engine 116. Within the AI engine 116, a JSON description generator 118 produces stimulus descriptions. A Python function module 120 takes stimulus descriptions from the AI engine 116 as input and uses libraries 122 to generate the stimulus. Finally, the system stores the output stimulus in a database along with their corresponding mathematics questions.

The stimulus image generation system uses automated load-balancing techniques to optimize the generation of stimulus images using the AI engine 116 and the Python function module 120. The load-balancing techniques distribute the workload efficiently, allowing the stimulus image generation system to handle multiple tasks simultaneously and improve overall performance. The load-balancing mechanism automatically allocates tasks between the AI engine 116, which generates stimulus descriptions, and the Python function module 120, which creates the stimulus. The load-balancing techniques prevent bottlenecks, reduce latency, and enhance scalability. The stimulus image generation system uses various strategies, such as round-robin distribution, the least connections method, or resource-based allocation, to dynamically adjust the workload based on demands and component capacities.

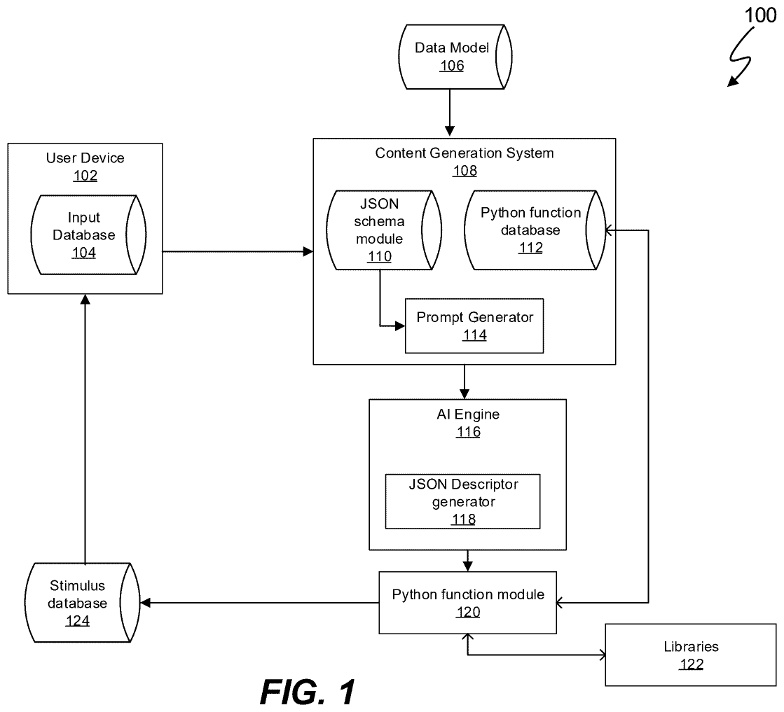

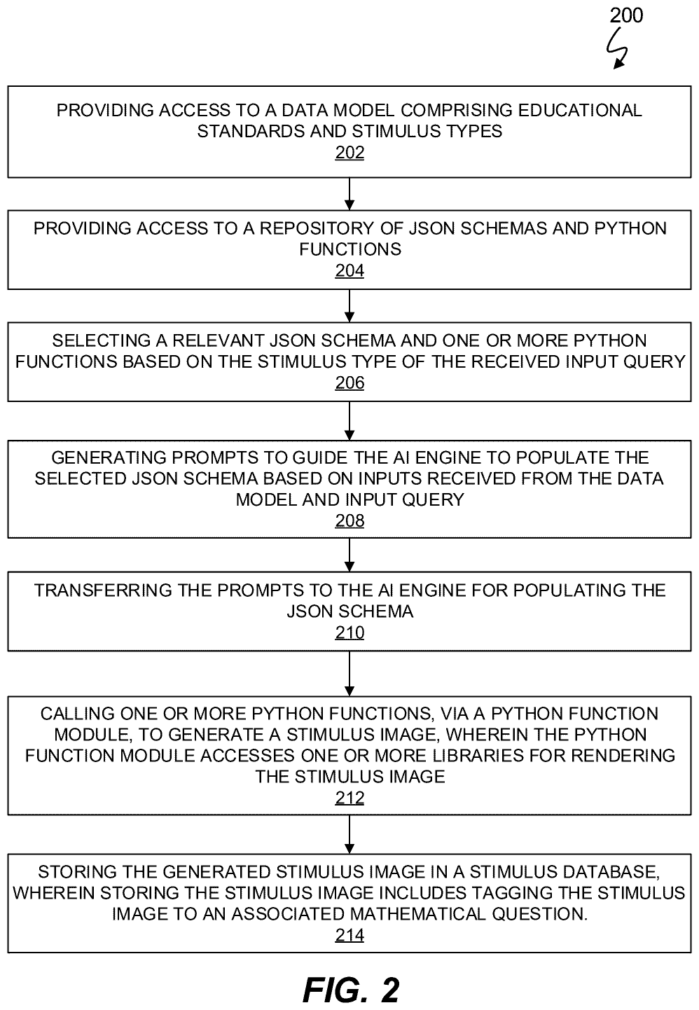

FIG. 1 depicts an exemplary stimulus image generation system 100 and FIG. 2 depicts an exemplary stimulus image generation method 100 utilized by the stimulus image generation system 100.

In operation 202, the content generation system 108 is given access to the data model 106 comprising educational standards and stimulus types. Wherein, an educational standard is a set of learning goals that specify what the user should know and be able to do at each grade level. The educational standards are designed to ensure consistent, high-quality education across schools and states. The educational standard guides curriculum development, teaching strategies, and assessment practices. For example, the common core state standards (CCSS) for mathematics require students in the third grade to be able to multiply and divide within 100, understand fractions, and solve problems involving area. The educational standard ensures that all students at this grade level are achieving the same foundational math skills.

Stimulus image refers to one or more visual representations, such as a diagram, chart, graph, or geometric figure, that are provided to make a response or guide the user toward solving the problem. The image serves as a key element of the question, offering necessary information or context for solving the given task. For example, a question includes a graph of a quadratic function. The stimulus image would be the graph itself, and the question could ask: “Based on the graph provided, determine the x-values where the function crosses the x-axis.” Here, the stimulus image is essential for the user to interpret the visual data and answer the question.

Mapping educational standards to one or more relevant stimulus types allows the user to clearly understand the stimulus and interpret the stimulus more effectively when the stimulus corresponds to the educational standards. The mapping is crucial because the information required to generate a geometric shape varies significantly between lower and higher educational standard users. The stimulus types are then associated with JSON schemas and python functions. The multi-level mapping between stimulus types with educational standards, JSON schemas, and python functions ensures that, for any given standard, the content generation system 108 can quickly identify the correct schema and function to generate the appropriate stimulus image.

In operation 204, the content generation system 108 receives access to a repository of JSON schema module 110 and python function database 112. The JSON schema module 110 contains JSON schemas and identifiers for AI assistants. The JSON schema defines the structure and format of JSON data, specifying required fields, data types, and rules for validation. The identifiers for AI assistants are specific terms or signals used to identify the AI engine 116, which can be used for the generation of specific stimulus descriptions. A plurality of python functions present inside the python function database 112 gives the instructions regarding the generation of the image by the python function module 120.

The content generation system 108 determines which JSON schema and python function need to be selected according to the input query from an input database 104. Where the input query is collected from a user device 102 and stored in the input database 104. The content generation system 108 maps the stimulus type with at least one JSON schema and one or more python functions, thereby mapping the educational standards to relevant JSON schemas and python functions.

In operation 206, the content generation system 108 selects a relevant JSON schema and one or more Python functions based on the stimulus type of the received input query. An input is received through the user device 102; the received input is stored in the input database 104; the input data is then transferred to the content generation system 108. The content generation system 108 selects the stimulus type and educational standards from the data model 106. The content generation system 108 then selects a JSON schema and python function corresponding to educational standards and stimulus type.

In at least one embodiment a variable called ‘Stimulus_Type_Specifications’ that serves as a general description of the stimulus type is used to receive input query from the user device 102 along with the input database 104. The ‘Stimulus_Type_Specifications’ variable then maps with other data such as educational standards, JSON schemas, and python functions. The ‘Stimulus_Type_Specifications’ is used by the prompt generator 114 to input into the AI engine 116 which populates the stimulus JSON schemas.

Example Stimulus Type Specification:

```
  Summary:
  The Stimulus is one geometric shape with a title. The shape is
accurately drawn to scale and includes specified lengths for its base
and height.
  Specifications:
  - The type of shape and length of the base and height must be
specified.
  - The unit of measurement should be indicated for each length.
  - The shape type must be either “rectangle”, “triangle”, or
“parallelogram”.
```

In the above example, the variable ‘Stimulus_Type_Specifications’ defines the geometric shape to be generated, including its type, dimensions, and units of measurement according to the user's input query through the user device 102.

In operation 208, the prompt generator 114 generates an input prompt to guide and constrain the AI engine 116 to populate the selected JSON schema based on the input query received from the data model 106 and input database 104. Wherein the prompts include one or more functions for generating stimulus descriptions relevant to the mapped stimulus type. The prompts are created by the prompt engineers and is modified by the prompt generator 114 inside the content generation system 108.

In at least one embodiment, the input prompt created by the prompt engineer and modified by the prompt generator 114 with respect to input query from the input database 104 and input from the data model 106 for geometric shape with base and height MCQ is:

```
  Core Inputs:
  --------
  Grade Level: 7
  Educational Standard: Solve problems involving computing areas
from a scale drawing.
  Stimulus Type Specifications: Summary:
  The Stimulus is one geometric shape with a title. The shape is
accurately drawn to scale and includes specified lengths for its base
and height.
  Specifications:
  - The type of shape and length of the base and height must be
specified.
  - The unit of measurement should be indicated for each length.
  - The shape type must be either “rectangle”, “triangle”, or
“parallelogram”.
  Example Question: Question: Below is the scale drawing of the
parking lot. The scale factor of the drawing to the parking lot is
represented by $1$ cm for every $15$ feet. Based on the scale
drawing, what is the area in square feet of the actual parking lot?\\
  \\
  Option A:\\
  Answer: 6144 square feet\\
  Correct: False\\
  \\
  Option B:\\
  Answer: 9216 square feet\\
  Correct: True\\
  \\
  Option C:\\
  Answer: 8640 square feet\\
  Correct: False\\
  \\
  Option D:\\
  Answer: 12000 square feet\\
  Correct: False\\
  \\
  Explanation: This is correct. The actual dimensions convert to
$48$ feet by $192$ feet, and multiplying these gives an area of
$9216$ square feet.
  Example Stimulus Description: {‘title’: ‘Rectangular Parking
Lot Scale Drawing’, ‘shape_type’: ‘rectangle’, ‘height_label’: ‘3.2
cm’, ‘base_label’: ‘12.8 cm’}
```

The above mentioned input prompt tasks the AI engine 116 to calculate the actual area of the parking lot in square feet, using the given scale and dimensions from the drawing. Four answer options are provided, and the correct answer is determined by correctly converting the dimensions and calculating the area of the actual parking lot. The stimulus describes a scale drawing titled “Rectangular Parking Lot Scale Drawing”, which features a rectangle representing the parking lot. The rectangle is accurately drawn to scale, with the height labeled as 3.2 cm and the base labeled as 12.8 cm. These measurements correspond to the dimensions of the parking lot in the scale drawing.

In at least one embodiment, the input prompt created by the prompt engineer and modified by the prompt generator 114 with respect to input query from the input database 104 and input from the data model 106 for bar graph MCQ is:

```
  Core Inputs:
  --------
  Grade Level: 1
  Educational Standard: Ask and answer questions about how many
less data points are in one category than in another.
  Stimulus Type Specifications: Summary:
  The Stimulus is a graphical representation of categorical data
using bar graphs, histograms, or picture graphs. The chart is clearly
titled to reflect the data being represented, with categorical axes
and numerical measurements facilitating data interpretation.
  Specifications:
  - The graph must have a title that directly relates to the
content being displayed.
  - The x-axis should be labeled with categories relevant to the
data (e.g., types of products, services, or ranges of integers).
  - The y-axis should be labeled with numerical values indicating
measurements (e.g., sales in units, frequency, percentages).
  - Each data point in the graph must represent a distinct
category with a specific value indicated, ensuring each category is
distinctly separated to avoid confusion.
  Example Question: Question: How many less people voted for ice
cream than pizza?\\
  \\
  Option A:\\
  Answer: 6\\
  Correct: False\\
  Explanation: Whoops! Looks like you added or subtracted wrong.
Pizza got 5 more votes than Ice Cream.
  \\
  Option B:\\
  Answer: 3\\
  Correct: False\\
  Explanation: Whoops! Looks like you might have looked at the
wrong categories.
  \\
  Option C:\\
  Answer: 5\\
  Correct: True\\
  Explanation: Great job! You found out that Ice Cream got 5 less
votes than Pizza.
  \\
  Example Stimulus Description: [{‘graph_type’: ‘bar_graph’,
‘title’: ‘Favorite Foods Survey’, ‘x_axis_label’: ‘Food’,
‘y_axis_label’: ‘Votes', ‘data’: [{‘category’: ‘Pizza’, ‘frequency’:
9}, {‘category’: ‘Ice Cream’, ‘frequency’: 4}, {‘category’: ‘Hot
Dog’, ‘frequency’: 7}, {‘category’: ‘Burger’, ‘frequency’: 5}]}]
```

The above mentioned input prompt tasks the AI engine 116 to generate questions about comparing data points from different categories, specifically focusing on how many fewer data points one category has compared to another. Along with the question a bar graph titled “Favorite Foods Survey”, which visually displays data on how many votes different foods received in a survey. The x-axis is labeled “Food”, showing categories such as pizza, ice cream, hot dogs, and burgers, while the y-axis is labeled “Votes”, indicating the number of votes each food received. The graph needs to show that pizza received 9 votes, ice cream received 4 votes, hot dogs received 7 votes, and burgers received 5 votes.

In at least one embodiment, the input prompt created by the prompt engineer and updated by the prompt generator 114 with respect to input data from the input database 104 and input from the data model 106 for inequality number line MCQ is:

```
  Core inputs:
  --------
  Grade Level: 7
  Educational Standard: Graph the solution sets of inequalities
on a number line and interpret the graphed solution in the context of
the problem.
  Stimulus Type Specifications: Summary:
  The Stimulus is a number line displaying points and lines to
indicate inequalities.
  Specifications:
  - The number line will have a defined range with integer
minimum and maximum values.
  - All points on the number line will be integers within the
defined range.
  - Each point will have a fill value indicating its inclusion
(filled) or exclusion (unfilled) in the inequality statement.
  - Lines are used to represent the lower and upper bounds of a
valid range within the inequality statement. When representing an
open-ended inequality statement, the corresponding bound (min or max)
will be set to None.
  Example Question: Question: Use the number line provided to
determine the solution set for the inequality $15 \leq 7x + 1$\\
  \\
  Option A:\\
  Answer: $x \leq 2$\\
  Correct: False\\
  Explanation: This choice says $x$ is less than or equal to 2.
But the inequality $15 \leq 7x + 1$ is true when $x$ is greater than
or equal to 2, not less.
  \\
  Option B:\\
  Answer: $2 < x < 7$\\
  Correct: False\\
  Explanation: This choice limits $x$ to values between 2 and 7.
The correct inequality does not have an upper limit; it only requires
that $x$ is greater than or equal to 2.
  \\
  Option C:\\
  Answer: $x > 2$\\
  Correct: False\\
  Explanation: This choice says $x$ is greater than 2, but it
misses that $x$ can also be exactly 2, where the inequality still
holds.
  \\
  Option D:\\
  Answer: $x \geq 2$\\
  Correct: True\\
  Explanation: This choice correctly states $x$ is greater than
or equal to 2. It matches the inequality since $x=2$ makes $15 = 15$,
and any $x$ greater than 2 will make $7x + 1$ larger than 15.
  \\
  Example Stimulus Description: {‘range’: {‘min’: −3, ‘max’: 7},
‘points': [{‘fill’: True, ‘value’: 2}], ‘lines': [{‘min’: 2, ‘max’:
None}]}
```

The input prompt tasks the AI engine 116 for the generation of MCQ based on a number line, example stimulus description provides a structured format for representing inequalities on a number line. The ‘range’: {‘min’: −3, ‘max’: 7}: defines the span of the number line, which starts at −3 and ends at 7. All points and solutions will fall within this range of integer values. ‘points’: {‘fill’: True, ‘value’: 2}: describes a specific point on the number line. ‘lines’: [{‘min’: 2, ‘max’: None}] represents a line on the number line that starts at 2 and extends indefinitely to the right. The ‘min’ value is 2, indicating the lower bound, and the ‘max’ value is None, meaning there is no upper bound.

In operation 210, the content generation system 108 transfers the prompts to the AI engine 116 for populating the JSON schema. where the prompt includes the input prompt, guiding prompt, JSON schema, and functions.

Example for a function containing MCQ and stimulus schema. The below function is created by the prompt engineers and modified by the content generation system 108 according to the input query:

```
  {
    “name”: “generateMCQ4Choice”,
    “description”: “Generate a Multiple-Choice Question (MCQ) for
math students based on the Grade Level, Educational Standard, and
Example Question, including a possible visual stimulus.”,
    “parameters”: {
      “type”: “object”,
      “properties”: {
        “question_text_with_inline_latex”: {
          “type”: “string”,
          “description”: “The multiple-choice question written in
text with inline LaTeX.”
        },
        “stimulus_description”: {
          “type”: “object”,
          “properties”: {
            “title”: {
              “type”: “string”
            },
            “shape_type”: {
              “type”: “string”,
              “description”: “Either ‘rectangle’, ‘triangle’, or
‘parallelegram’.”
            },
            “height_label”: {
              “type”: “string”,
              “description”: “A text label displaying the
vertical dimension of the shape, consisting of a numeric value and
its corresponding unit of measurement.”
            },
            “base_label”: {
              “type”: “string”,
              “description”: “A text label displaying the
horizontal dimension of the shape, consisting of a numeric value and
its corresponding unit of measurement.”
            }
          },
          “required”: [
            “title”,
            “shape_type”,
            “height_label”,
            “base_label”
          ]
        },
        “A_text_with_inline_latex”: {
          “type”: “string”,
          “description”: “Answer A written in text with inline
LaTeX.”
        },
        “A_explanation_text_with_inline_latex”: {
          “type”: “string”,
          “description”: “Explanation for answer A, explaining
why it is either correct or incorrect, written in text with inline
LaTeX.”
        },
        “A_correct”: {
          “type”: “boolean”,
          “description”: “Indicates whether answer A is the
correct answer.”
        },
        “B_text_with_inline_latex”: {
          “type”: “string”,
          “description”: “Answer B written in text with inline
LaTeX.”
        },
        “B_explanation_text_with_inline_latex”: {
          “type”: “string”,
          “description”: “Explanation for answer B, explaining
why it is either correct or incorrect, written in text with inline
LaTeX.”
        },
        “B_correct”: {
          “type”: “boolean”,
          “description”: “Indicates whether answer B is the
correct answer.”
        },
        “C_text_with_inline_latex”: {
          “type”: “string”,
          “description”: “Answer C written in text with inline
LaTeX.”
        },
        “C_explanation_text_with_inline_latex”: {
          “type”: “string”,
          “description”: “Explanation for answer C, explaining
why it is either correct or incorrect, written in text with inline
LaTeX.”
        },
        “C_correct”: {
          “type”: “boolean”,
          “description”: “Indicates whether answer C is the
correct answer.”
        },
        “D_text_with_inline_latex”: {
          “type”: “string”,
          “description”: “Answer D written in text with inline
LaTeX.”
        },
        “D_explanation_text_with_inline_latex”: {
          “type”: “string”,
          “description”: “Explanation for answer D, explaining
why it is either correct or incorrect, written in text with inline
LaTeX.”
        },
        “D_correct”: {
          “type”: “boolean”,
          “description”: “Indicates whether answer D is the
correct answer.”
        }
      },
      “required”: [
        “question_text_with_inline_latex”,
        “stimulus_description”,
        “A_text_with_inline_latex”,
        “A_explanation_text_with_inline_latex”,
        “A_correct”,
        “B_text_with_inline_latex”,
        “B_explanation_text_with_inline_latex”,
        “B_correct”,
        “C_text_with_inline_latex”,
        “C_explanation_text_with_inline_latex”,
        “C_correct”,
        “D_text_with_inline_latex”,
        “D_explanation_text_with_inline_latex”,
        “D_correct”
      ]
    }
  }
```

The above mentioned function “generateMCQ4Choice”, creates a comprehensive MCQ for math students. The function “generateMCQ4Choice” takes into account the students' grade level, relevant educational standards, and an example question to produce a tailored MCQ. The function “generateMCQ4Choice” generates a question text that incorporates inline LaTeX for mathematical notation, ensuring clarity and precision in the presentation of mathematical concepts.

The function “generateMCQ4Choice” includes a stimulus as part of the question. The function “generateMCQ4Choice” describes a geometric shape (either a rectangle, triangle, or parallelogram) with specific dimensions, providing a title and labels for the shape's height and base. This stimulus element enhances the question's complexity and helps assess users' ability to apply mathematical concepts to visual representations.

The function “generateMCQ4Choice” creates four answer choices (A, B, C, and D), each written with inline LaTeX for proper mathematical formatting. For every answer choice, the function “generateMCQ4Choice” provides an explanation that justifies why the answer is correct or incorrect, also using inline LaTeX where necessary. Additionally, the function designates which of the four answers is correct through boolean values.

Example for a prompt to populate MCQ and stimulus schema. The below prompt is created by the prompt engineers and updated by the content generation system 108:

```
  Context
  --------
  You are a Mathematics Multiple-Choice Question (MCQ) generator.
Your job is to create a challenging but fair MCQ for a mathematics
exam of the given Grade Level.
  Task
  --------
  1. Use the Educational Standard to generate an MCQ question
along with a Stimulus Description. Mimic the style and structure of
the Example Question and Example Stimulus while ignoring their
content.
  2. Generate four answer choices for the MCQ. Exactly one of the
answer choices must be correct.
  3. Each answer must be accompanied by an explanation as to why
this answer is correct or incorrect.
  4. Output the generated multiple-choice question (MCQ) using
the functions. generateMCQ4Choice tool.
  Rules
  --------
  Formatting:
  * Do NOT include large, complicated fractions such as 17/190 in
any outputs. If included, fractions should be simple, such as 7/8 or
3/5.
  * For all outputs, write out “pi,” “e,” or their mathematical
representations. Do not write out “3.14159265...” or “2.718...”
  * If any decimal places are truncated in the answer choices,
ensure the question wording matches the truncation/rounding (e.g.,
“Round to the nearest integer”).
  Stimulus Description:
  * Use the Summary given in the Stimulus Type Specifications to
understand the type of stimulus that can be created.
  * Follow the Specifications given in Stimulus Type
Specifications.
  * Create a Stimulus Description using a similar structure to
the Example Stimulus Description while ignoring its content.
  * Integrate the MCQ with the visuals that the Stimulus
Description describes
  * Generate the minimum number of visual Stimuli necessary to
create a solvable MCQ. Do not generate any Stimuli that will not be
referenced by either the Answer Choices or Question.
  Question:
  * Assume a visual stimulus following the generated Stimulus
Description is given. Create an MCQ to accompany this stimulus.
  * The question must not be answerable without the information
conveyed by the stimulus.
  * Do not explicitly state the Stimulus Description.
  * The generated MCQ MUST conform to a multiple-choice format.
  * The question should not ask for anything except one correct
answer.
  Answer Choices:
  * There must only be one correct answer. There should be no
ambiguity between the correct and incorrect answers for a student of
the Grade Level besides knowledge of the Educational Standard.
  * Ensure that answer choices cannot be immediately discounted
due to question formatting, such as formatting differences between
the correct answer choice and the incorrect answer choice.
  * Refer to Stimuli in answer choices only by their labels, such
as “A,” “B,” etc. Never describe Stimuli qualitatively.
  * If the answer options involve units of measurement, ensure
that all options use the same unit type. Only the numerical values
should vary between options.
  Answer Explanations:
  * The_correct answer choice explanation should give a clear,
coherent, step-by-step explanation for the correct answer
  * Ignore the tone of the answer explanations from the Example
Question. Use a neutral tone that is not targeted at any demographic.
  * Incorporate the stimulus described by the Stimulus
Description into the explanation if relevant.
  * Do not explicitly state the Stimulus Description.
  Output Template
  --------
  Question: The text-based component of the MCQ
  Stimulus Description: An object detailing the stimulus to be
generated. The format should be aligned with the Example Question.
  An Explanation: The explanation for the correctness of answer
choice A
  A Correct: The_correctness of answer choice A
  B Text: The text for answer choice B
  B Explanation: The explanation for the correctness of answer
choice B
  B Correct: The_correctness of answer choice B
  C Text: The text for answer choice C
  C Explanation: The explanation for the correctness of answer
choice C
  C Correct: The_correctness of answer choice C
  D Text: The text for answer choice D
  D Explanation: The explanation for the correctness of answer
choice D
  D Correct: The_correctness of answer choice D
```

The above mentioned prompt tasks the AI engine 116 with creating challenging but fair MCQs for mathematics exams at a specified grade level. The AI engine 116 must use provided educational standards to generate questions and stimulus descriptions, mimicking the style and structure of given examples while ignoring their specific content. For each MCQ, the AI engine 116 generates four answer choices, with exactly one being correct. The AI engine 116 must accompany each answer with an explanation detailing why the answer is correct or incorrect. The prompt instructs the AI engine 116 to output the generated MCQ using a specific function, “generateMCQ4Choice”.

The prompt provides several rules for formatting and content creation. The prompt prohibits the use of large, complicated fractions and specifies how to write mathematical constants like pi and e. The prompt also guides and constrains the AI engine 116 on creating stimulus descriptions, integrating MCQs with visual elements, and ensuring questions are not answerable without the provided stimulus information. When crafting questions and answer choices, the AI engine 116 adheres to specific guidelines. Questions should conform to a multiple-choice format and ask for only one correct answer. Answer choices should avoid ambiguity and maintain consistent formatting. The prompt emphasizes the importance of referring to stimuli by their labels and using consistent units of measurement across answer options.

The prompt instructs the AI engine 116 to create a stimulus description for each mathematics MCQ, detailing visual or textual information that accompanies the question. The AI engine 116 must follow specific guidelines, using provided specifications to craft the stimulus description similar in structure to an example while developing unique content. The stimulus plays a crucial role in the MCQ: the AI engine 116 must integrate stimulus description with the question and answer choices, ensure the question isn't answerable without stimulus description, and refer to stimulus only by labels in the answers. The AI engine 116 should generate the minimum necessary visual stimuli, incorporate them into answer explanations when relevant, and avoid explicitly stating the stimulus description.

Example for a prompt for populating MCQ and stimulus schema related to geometric shape with base and height. The below prompt is created by the prompt engineers and modified by the content generation system 108:

```
  Context
  --------
  You are a Mathematics Multiple-Choice Question (MCQ) generator.
Your job is to create a challenging but fair MCQ for a mathematics
exam of the given Grade Level.
  Task
  --------
  1. Use the Educational Standard to generate an MCQ question
along with a Stimulus Description. Mimic the style and structure of
the Example Question and Example Stimulus while ignoring their
content.
  2. Generate four answer choices for the MCQ. Exactly one of the
answer choices must be correct.
  3. Each answer must be accompanied by an explanation as to why
this answer is correct or incorrect.
  4. Output the generated multiple-choice question (MCQ) using
the functions.generateMCQ4Choice tool.
  Rules
  --------
  Formatting:
  * Do NOT include large, complicated fractions such as 17/190 in
any outputs. If included, fractions should be simple, such as 7/8 or
3/5.
  * For all outputs, write out “pi,” “e,” or their mathematical
representations. Do not write out “3.14159265...” or “2.718...”
  * If any decimal places are truncated in the answer choices,
ensure the question wording matches the truncation/rounding (e.g.,
“Round to the nearest integer”).
  Stimulus Description:
  * Use the Summary given in the Stimulus Type Specifications to
understand the type of stimulus that can be created.
  * Follow the Specifications given in Stimulus Type
Specifications.
  * Create a Stimulus Description using a similar structure to
the Example Stimulus Description while ignoring its content.
  * Integrate the MCQ with the visuals that the Stimulus
Description describes
  * Generate the minimum number of visual Stimuli necessary to
create a solvable MCQ. Do not generate any Stimuli that will not be
referenced by either the Answer Choices or Question.
  Question:
  * Assume a visual stimulus following the generated Stimulus
Description is given. Create an MCQ to accompany this stimulus.
  * The question must not be answerable without the information
conveyed by the stimulus.
  * Do not explicitly state the Stimulus Description.
  * The generated MCQ MUST conform to a multiple-choice format.
  * The question should not ask for anything except one correct
answer.
  Answer Choices:
  * There must only be one correct answer. There should be no
ambiguity between the correct and incorrect answers for a student of
the Grade Level besides knowledge of the Educational Standard.
  * Ensure that answer choices cannot be immediately discounted
due to question formatting, such as formatting differences between
the correct answer choice and the incorrect answer choice.
  * Refer to Stimuli in answer choices only by their labels, such
as “A,” “B,” etc. Never describe Stimuli qualitatively.
  * If the answer options involve units of measurement, ensure
that all options use the same unit type. Only the numerical values
should vary between options.
  Answer Explanations:
  * The_correct answer choice explanation should give a clear,
coherent, step-by-step explanation for the correct answer
  * Ignore the tone of the answer explanations from the Example
Question. Use a neutral tone that is not targeted at any demographic.
  * Incorporate the stimulus described by the Stimulus
Description into the explanation if relevant.
  * Do not explicitly state the Stimulus Description.
  Output Template
  --------
  Question: The text-based component of the MCQ
  Stimulus Description: An object detailing the stimulus to be
generated. The format should be aligned with the Example Question.
  An Explanation: The explanation for the correctness of answer
choice A
  A Correct: The_correctness of answer choice A
  B Text: The text for answer choice B
  B Explanation: The explanation for the correctness of answer
choice B
  B Correct: The_correctness of answer choice B
  C Text: The text for answer choice C
  C Explanation: The explanation for the correctness of answer
choice C
  C Correct: The_correctness of answer choice C
  D Text: The text for answer choice D
  D Explanation: The explanation for the correctness of answer
choice D
  D Correct: The_correctness of answer choice D
```

The above mentioned prompt instructs the AI engine 116 to create a mathematics MCQ for a specific grade level exam. The prompt requires the AI engine 116 to generate a question, four answer choices, and a stimulus description. The stimulus description should detail a visual element that's crucial for solving the question. The AI engine 116 must create this stimulus description based on given specifications, ensuring the stimulus description provides enough information for the question to be solvable. The question itself should be impossible to answer without the stimulus.

When generating the MCQ, the AI engine 116 needs to follow strict formatting rules. These include avoiding complex fractions, using specific notations for mathematical constants, and matching any rounding in the question to the answer choices. The question should be challenging yet fair, conforming to the given educational standard. For the answer choices, the AI engine 116 must provide exactly one correct option and three incorrect ones. Each choice needs an accompanying explanation detailing why it's right or wrong. These explanations should be step-by-step, neutral in tone, and reference the stimulus when relevant. The choices should be equally plausible to a user at the specified grade level, with no obvious tells that would allow easy elimination.

The prompt emphasizes the importance of integrating the question with the described stimulus. The AI engine 116 should only generate the minimum necessary stimulus description, avoiding any extraneous information. When referring to the stimulus in the question or answer choices, the AI engine 116 should use labels like “A” or “B” rather than qualitative descriptions.

The output from the above prompt is:

```
Stimulus_description JSON:
{
  “title”: “Rectangular Parking Lot Scale Drawing”,
  “shape_type”: “rectangle”,
  “height_label”: “2.8 inches”,
  “base_label”: “3.2 inches”
}
```

Example for a prompt for populating MCQ and stimulus schema related to bar graph. The below prompt is created by the prompt engineers and modified by the content generation system 108:

```
  Context
  --------
  You are a Mathematics Multiple-Choice Question (MCQ) generator.
Your job is to create a challenging but fair MCQ for a mathematics
exam of the given Grade Level.
  Task
  --------
  1. Use the Educational Standard to generate an MCQ question
along with a Stimulus Description. Mimic the style and structure of
the Example Question and Example Stimulus while ignoring their
content.
  2. Generate four answer choices for the MCQ. Exactly one of the
answer choices must be correct.
  3. Each answer must be accompanied by an explanation as to why
this answer is correct or incorrect.
  4. Output the generated multiple-choice question (MCQ) using
the functions.generateMCQ4Choice tool.
  Rules
  --------
  Formatting:
  * Do NOT include large, complicated fractions such as 17/190 in
any outputs. If included, fractions should be simple, such as 7/8 or
3/5.
  * For all outputs, write out “pi,” “e,” or their mathematical
representations. Do not write out “3.14159265...” or “2.718...”
  * If any decimal places are truncated in the answer choices,
ensure the question wording matches the truncation/rounding (e.g.,
“Round to the nearest integer”).
  Stimulus Description:
  * Use the Summary given in the Stimulus Type Specifications to
understand the type of stimulus that can be created.
  * Follow the Specifications given in Stimulus Type
Specifications.
  * Create a Stimulus Description using a similar structure to
the Example Stimulus Description while ignoring its data. The
stimulus you create must use the same graph_type as the Example
question.
  * Integrate the MCQ with the visuals that the Stimulus
Description describes
  * Generate the minimum number of visual Stimuli necessary to
create a solvable MCQ. Do not generate any Stimuli that will not be
referenced by either the Answer Choices or Question.
  * The type of graph mentioned in the Educational Standard must
be the type of graph used in the stimulus.
  * Picture graphs must not contain more than 4 categories.
  Question:
  * Assume a visual stimulus following the generated Stimulus
Description is given. Create an MCQ to accompany this stimulus.
  * Do not explicitly state the Stimulus Description.
  * The generated MCQ MUST conform to a multiple-choice format.
  * The question should not ask for anything except one correct
answer.
  * Category names should only be capitalized in the question
text if they are proper nouns, but must always be capitalized in the
stimulus descriptions.
  Answer Choices:
  * There must only be one correct answer. There should be no
ambiguity between the correct and incorrect answers for a student of
the Grade Level besides knowledge of the Educational Standard.
  * Ensure that answer choices cannot be immediately discounted
due to question formatting, such as formatting differences between
the correct answer choice and the incorrect answer choice.
  * Refer to Stimuli in answer choices only by their labels, such
as “A,” “B,” etc. Never describe Stimuli qualitatively.
  Answer Explanations:
  * The_correct answer choice explanation should give a clear,
coherent, step-by-step explanation for the correct answer
  * Ignore the tone of the answer explanations from the Example
Question. Use a neutral tone that is not targeted at any demographic.
  * Incorporate the stimulus described by the Stimulus
Description into the explanation if relevant.
  * Do not explicitly state the Stimulus Description.
  Output Template
  --------
  Question: The text-based component of the MCQ
  Stimulus Description: An object detailing the stimulus to be
generated. The format should be aligned with the Example Question.
  An Explanation: The explanation for the correctness of answer
choice A
  A Correct: The_correctness of answer choice A
  B Text: The text for answer choice B
  B Explanation: The explanation for the correctness of answer
choice B
  B Correct: The_correctness of answer choice B
  C Text: The text for answer choice C
  C Explanation: The explanation for the correctness of answer
choice C
  C Correct: The_correctness of answer choice C
  D Text: The text for answer choice D
  D Explanation: The explanation for the correctness of answer
choice D
  D Correct: The_correctness of answer choice D
```

The above mentioned prompt instructs the AI engine 116 to create a mathematics MCQ for a specific grade level exam. The AI engine 116 must generate a question, four answer choices, and a stimulus description. The stimulus description plays a crucial role in this task. The AI engine 116 needs to create a stimulus that is essential for solving the question, based on the provided stimulus type specifications. The AI engine 116 description should follow the structure of the Example Stimulus Description, but with the AI engine 116 own data. Importantly, the AI engine 116 must use the same graph type as mentioned in the Example question and the Educational Standard. When creating the stimulus, the AI engine 116 should generate only the minimum number of visual elements necessary for a solvable MCQ. The stimulus must align with the graph type specified in the educational standard. For picture graphs, the AI engine 116 limited to a maximum of four categories. The AI engine 116 question should be impossible to answer without the stimulus, emphasizing the integration between the question and the described stimulus.

The MCQ generation process involves strict formatting rules. The AI engine 116 should avoid complex fractions, use specific notations for mathematical constants, and ensure any rounding in the question matches the answer choices. The question should challenge the user while remaining fair and adhering to the given educational standard. In the question text, only capitalize category names if they're proper nouns, but always capitalize them in stimulus descriptions. For answer choices, provide one correct option and three incorrect ones. Each choice needs an explanation detailing why it's right or wrong. These explanations should be step-by-step, neutral in tone, and reference the stimulus when relevant. Ensure all choices are equally plausible to the user at the specified grade level, with no obvious indicators allowing easy elimination.

When referencing the stimulus in the question or answer choices, use labels like “A” or “B” rather than qualitative descriptions. The final output should follow the provided template, including fields for the question text, stimulus description, and each answer choice with its explanation and correctness indicator.

Example for a prompt for populating MCQ and stimulus schema related to inequality number line. The below prompt is created by the prompt engineers and modified by the content generation system 108:

```
  Context
  --------
  You are a Mathematics Multiple-Choice Question (MCQ) generator.
Your job is to create a challenging but fair MCQ for a mathematics
exam at the given Grade Level.
  Task
  --------
  1. Use the Educational Standard to generate an MCQ along with a
Stimulus Description. Mimic the style and structure of the Example
Question and Example Stimulus.
  2. Generate four answer choices for the MCQ. Exactly one of the
answer choices must be correct.
  3. Write and run code to output the generated MCQ in valid JSON
using the functions.generateMCQ4Choice tool.
  Rules
  --------
  Stimulus Description:
  * The Stimulus Type Specifications should be used to understand
the number line that will be created.
  * The number line's range must be less than 15 units.
  Question:
  * The MCQ must be written assuming the number line following
the generated Stimulus Description is shown. The question should not
restate the information present in the stimulus.
  * The MCQ must mimic the style and structure of the Example
Question.
  * The MCQ values should be integers.
  * The question prompt must not give away the correct answer.
  Answer Choices:
  * There must only be one correct answer.
  * All answer choices should be consistent in format, structure,
length, and style.
  Output Template
  --------
  Question: The text-based component of the MCQ
  Stimulus Description: An object detailing the number line to be
generated.
  A Explanation: The explanation for the correctness of answer
choice A
  A Correct: The_correctness of answer choice A
  B Text: The text for answer choice B
  B Explanation: The explanation for the correctness of answer
choice B
  B Correct: The_correctness of answer choice B
  C Text: The text for answer choice C
  C Explanation: The explanation for the correctness of answer
choice C
  C Correct: The_correctness of answer choice C
  D Text: The text for answer choice D
  D Explanation: The explanation for the correctness of answer
choice D
  D Correct: The_correctness of answer choice D
```

The above mentioned prompt instructs the AI engine 116 to create a MCQ for a specific educational standards, focusing on number lines. The AI engine 116 must generate a question, four answer choices, and a stimulus description for a number line. For the stimulus description, the AI engine 116 needs to create a number line based on the stimulus type specifications. The number line's range must be less than 15 units. When creating the MCQ, the AI engine 116 should assume the described number line is shown to the user. The question should not restate information present in the stimulus, encouraging the user to interpret the visual independently. The AI engine 116 must mimic the style and structure of the provided example question. The question should use integer values to maintain simplicity and clarity.

For the answer choices, the AI engine 116 needs to provide four options, with exactly one being correct. All answer choices should be consistent in format, structure, length, and style. This consistency prevents students from eliminating options based on superficial differences. After generating the MCQ components, the AI engine 116 required to write and run code that outputs the generated MCQ in valid JSON format using the functions. generateMCQ4Choice tool. This step ensures the MCQ is properly formatted for further use or processing. The output should follow the provided template, which includes fields for the question text, stimulus description, and each answer choice with its explanation and correctness indicator.

The JSON schema is a variable that serves as a general description for different stimulus types. One or more JSON schemas are mapped to one or more stimulus types. The JSON schema is used by the AI engine 116 to populate the stimulus description for the stimulus type.

The JSON description generator 118 present inside the AI engine 116 populates the JSON schemas using prompts and functions. The JSON description generator 118 outputs the stimulus description according to the educational standards and with respect to the stimulus types.

The AI engine 116 uses a natural language processor (NLP) to extract relevant information such as numerical values, mathematical concepts, and contextual details. For example, if a question is, “What is the area of a circle with a radius of 5?”, the NLP identifies key components such as the term “area,” the shape “circle,” and the numerical value “5.” The NLP then retrieves the mathematical formula for calculating the area of a circle and applies the provided value to give an accurate response. The AI engine 116 also integrates one or more generative AI models, such as large language models and foundational models. These models enable the AI engine 116 to process and generate text, adapt to various tasks, and respond accurately to inputs.

In operation 212, the python function module 120 calls one or more Python functions, to generate a stimulus image, wherein the Python function module 120 accesses one or more the libraries 122 for rendering the stimulus image; The python functions are stored in the python function database 112 in the content generation system 108. The python function in the python function module 120 is mapped to stimulus types, JSON schema, and educational standard. The python function module 120 calls the python function from the python function database 112 present in the content generation system 108. The python function is called according to the stimulus types, JSON schema, and educational standard. The python function module 120 calls different python functions present in the python function database 112 according to the JSON schema.

Different python functions are called for the generation of different kinds of stimulus; for example, a function for the generation of a rectangle, parallelogram, or triangle is called for that purpose and if there is a generation of a number line, the python function mapped to the number line will be called by the python function module 120.

The python function module 120 uses different libraries 122 for the generation of the images. The Python function module 120 actively employs libraries 122 such as Matplotlib, Pillow, or OpenCV to create images based on the output given from the AI engine 116. The libraries 122 provide the necessary tools to handle image formats, apply filters, and perform pixel-level modifications.

Algorithm used:

```
  Algorithm: Generate Image
  Input: AI Populated JSON object (stimulus_description)
  Output: Image file
  Steps:
  1. Parse the JSON object to extract values.
  2. Set up the Matplotlib figure and axes.
  3. Draw the appropriate shapes and annotations depending on the
stimulus type.
  4. Save the figure to an image file.
  5. Close the figure to free up resources.
```

The algorithm begins by parsing the input stimulus description. The algorithm extracts the relevant values, such as the stimulus type, dimensions, colors, and any specific parameters needed for the particular stimulus. Next, the algorithm sets up a Matplotlib figure and axes. The algorithm creates a new figure with the appropriate size and initializes the axes where the stimulus will be drawn. This step prepares the canvas for the subsequent drawing operations.

The core of the algorithm lies in drawing the appropriate shapes and annotations based on the stimulus type. It uses Matplotlib's drawing functions to create the required visual elements. For example, if the stimulus is a Gabor patch, the algorithm generates the necessary sine wave pattern and applies a Gaussian envelope. If it's a simple geometric shape, the algorithm draws the shape using the specified parameters. The algorithm also adds any required annotations or labels as defined in the stimulus description.

After creating the representation of the stimulus, the algorithm saves the figure to an image file. The algorithm determines the appropriate file format (such as PNG or JPEG) and writes the image data to disk. This step creates a permanent record of the generated stimulus that can be used in further processing or displayed to users. Finally, the algorithm closes the Matplotlib figure to free up system resources. This step is crucial for efficient memory management, especially when generating multiple stimuli in succession.

Example of a python function for the generation of stimulus related to geometric shape with base and height:

```
  def generate_shape_with_base_and_height(params):
    shape_type = params[‘shape_type’]
    title = params[‘title’]
    height_label = params[‘height_label’]
    base_label = params[‘base_label’]
    fig, ax = plt.subplots(figsize=(6, 4))
    y_start = 2
    height = float(height_label.split( )[0])
    base = float(base_label.split ( )[0])
    right_edge = 2 + base
    if shape_type == ‘parallelogram’:
      right_edge += 1
    ax.set_xlim(0, right_edge + 2)
    ax.set_ylim(0, y_start + height + 4)
    ax.axis(‘off’)
    if shape_type == ‘rectangle’:
      shape = plt.Rectangle((2, y_start), base, height,
linewidth=1, edgecolor=‘r’, facecolor=‘none’)
      ax.add_patch(shape)
      title_x = 2 + base / 2
    elif shape_type == ‘parallelogram’:
      shape = plt.Polygon([[2, y_start], [2 + base, y_start],
[2 + base + 1, y_start + height], [2 + 1, y_start + height]],
linewidth=1, edgecolor=‘r’, facecolor=‘none’)
      ax.add_patch(shape)
      title_x = 2 + base / 2 + 0.5
    elif shape_type == ‘triangle’:
      shape = plt.Polygon([[2, y_start], [2 + base, y_start],
[2 + 0.5 * base, y_start + height]], linewidth=1, edgecolor=‘r’,
facecolor=‘none’)
      ax.add_patch(shape)
      title_x = 2 + base / 2
    ax.annotate(‘’, xy=(2, y_start − 0.3), xytext=(2 + base,
y_start − 0.3), arrowprops=dict(arrowstyle=‘<->’, color=‘blue’))
    ax.annotate(‘’, xy=(1.5, y_start), xytext= (1.5, y_start +
height), arrowprops=dict(arrowstyle=‘<->’, color=‘blue’))
    ax.annotate(base_label, (2 + base / 2, y_start − 0.8),
ha=‘center’)
    ax.annotate(height label, (0.8, y_start + height / 2),
va=‘center’, rotation=90)
    ax.text(title_x, y_start + height + 1, title, ha=‘center’,
fontsize=12, weight=‘bold’)
    ax.set_aspect(‘equal’, adjustable=‘box’)
    plt. subplots_adjust (left=0.2, right=0.98, top=0.9,
bottom=0.1)
    file_name =
f“{IMAGE_DESTINATION_FOLDER}/shape_{int(time.time( ))}.png”
    plt.savefig(file_name, dpi=300, bbox_inches=‘tight’)
    plt.close( )
    return file_name
```

The above mentioned function generates a geometric shape diagram based on the input parameters. The function creates either a rectangle, parallelogram, or triangle, depending on the specified shape type. The function uses Matplotlib to draw the shape and add labels. The function starts by extracting necessary information from the input parameters. The function retrieves the shape type, title, and labels for height and base. The function then sets up a Matplotlib figure and axis for drawing.

Next, the function calculates the dimensions of the shape based on the provided height and base labels. The function assumes the labels contain numeric values at the beginning. The function also determines the right edge of the shape, adding an extra unit for parallelograms to account for their slant. The function then sets the plot limits and turns off the axis display. Depending on the shape type, the function creates the appropriate geometric figure using Matplotlib's shape functions. For rectangles, the function uses rectangle; for parallelograms and triangles, the function uses polygon. The shape is drawn with a red outline and no fill.

After creating the shape, the function adds annotations for the base and height. It draws blue arrows to indicate these measurements and places the provided labels next to them. The base label goes below the shape, while the height label is rotated 90 degrees and placed to the left of the shape. The function then adds the title above the shape. Calculates the appropriate x-coordinate for centering the title based on the shape type.

To ensure the shape appears proportional, the function sets the aspect ratio of the plot to ‘equal’. The function also adjusts the subplot parameters to fine-tune the positioning of the diagram within the figure. Finally, the function saves the generated diagram as a PNG file in the specified destination folder. The file name includes a timestamp to ensure uniqueness. After saving, the function closes the Matplotlib figure to free up memory.

The python function module 120 interprets the JSON schema to understand the stimulus description and uses libraries 122 such as Mathplotlib to create the required stimulus image. where the library 122 provides pre-written code that developers can use to add specific functionalities. The python function module 120 also performs error handling and validation for the generated stimulus image.

Example for the stimulus generated by the python function module 120 for geometric shape with base and height:

Example for the stimulus generated by the python function module 120 for bar graph:

Example for the stimulus generated by the python function module 120 for geometric shape with base and height:

In operation 214, a stimulus database 124 stores the generated stimulus image, wherein storing the stimulus image includes tagging the stimulus image to an associated mathematical question. The python function module 120 generates a stimulus image that is delivered to the stimulus data base 124 and stored in the stimulus data base 124, where the stimulus image is saved in file format comprising WEBP, PNG, and SVG for display alongside the associated mathematical question.

The pseudocode for the stimulus image generation system 100 and stimulus image generation method 200:

```
  function generate_stimulus_image(edu_standard):
    # Identify stimulus type based on the educational standard
    stimulus_type = map_standard_to_stimulus_type(edu_standard)
    # Use AI to populate the JSON schema for the stimulus_type
    mcq_text, populated_stim_desc = ai_generate(edu_standard,
json_schema)
    # Create stimulus image using the populated schema
    stimulus_image =
stim_type_python_function(populated_stim_desc)
    # Store and return the MCQ and image file
    return store_mcq_and_image(mcq_text, stimulus_image)
```

This pseudocode outlines a function called ‘generate_stimulus_image’. The ‘generate_stimulus_image’ function generates output as a stimulus image along with a related MCQ. The ‘generate_stimulus_image’ function begins by identifying the appropriate stimulus type based on the given educational standard. The ‘generate_stimulus_image’ function does this by calling a function named ‘map_standard_to_stimulus_type’, which maps between educational standards and corresponding stimulus types.

Next, the ‘generate_stimulus_image’ function leverages the AI engine 116 to generate content. The ‘generate_stimulus_image’ function calls an ‘ai_generate’ function, providing the educational standard and a JSON schema as input. The AI engine 116 process accomplishes two tasks simultaneously: the AI engine 116 creates the text for a multiple-choice question related to the educational standard, and the AI engine 116 populates a JSON object (named ‘populated_stim_desc’) that describes the visual stimulus in detail.

With the stimulus description available, the ‘generate_stimulus_image’ function proceeds to create the actual stimulus image. The ‘generate_stimulus_image’ function does this by calling a python function specific to the identified stimulus type, passing the populated JSON description or stimulus description as an argument. The python function, represented here as ‘stim_type_python_function’, is responsible for rendering the visual stimulus based on the provided specifications.

Finally, the ‘generate_stimulus_image’ function calls ‘store_mcq_and_image’ to save both the generated multiple-choice question text and the stimulus image. The ‘generate_stimulus_image’ function concludes by returning the results of the ‘store_mcq_and_image’ operation. The return value allows the calling code to utilize or further process the generated materials as needed.

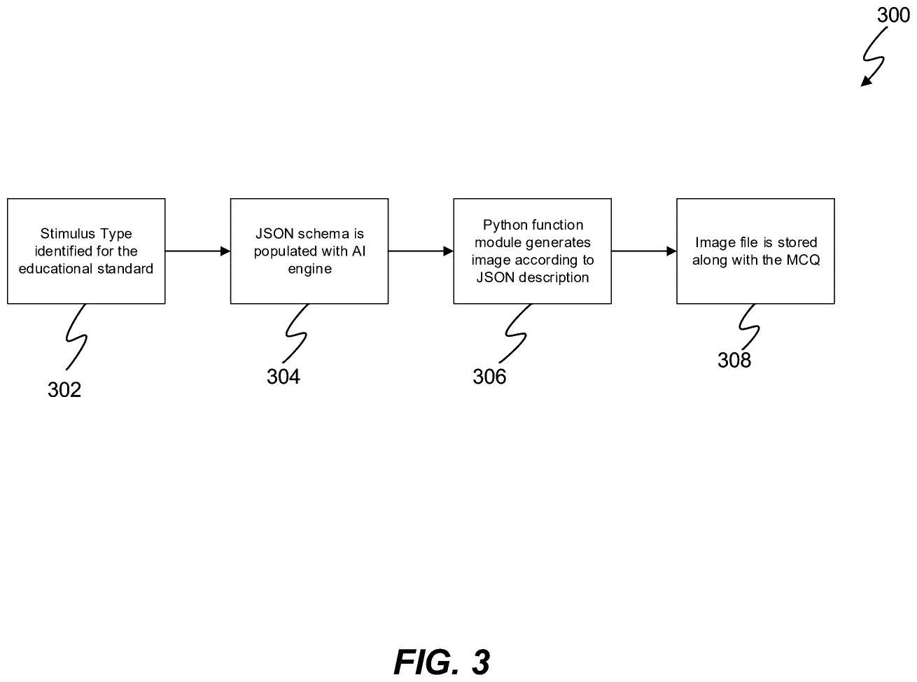

FIG. 3 depicts a flow for the stimulus image generation method, which is an embodiment of the stimulus image generation system 100 of FIG. 2. In step 302 stimulus type is identified for the educational standards, where the input is received through input database 104, which is mapped with the stimulus type and educational standards in the data model 106. Through mapping, the stimulus type is identified for the educational standard according to the input query.

In step 304 The JSON schema is populated with the AI engine 116, the JSON schema, serves as a general description for different stimulus types. One or more stimulus types map to one or more JSON schemas. The AI engine 116 uses the JSON schema to populate the stimulus description for the stimulus type.

In step 306, the python function module 120 generates an image according to JSON description. The python function module 120 interprets the JSON schema to understand the stimulus description and uses the libraries 122, such as Matplotlib, to create the required stimulus image. The library 122 offers pre-written code, enabling developers to easily add specific functionalities to the image generation process.

In step 308, the image file is stored along with the MCQ. The stimulus database 124 stores the generated stimulus image by tagging the stimulus image to an associated mathematical question. The Python function module 120 generates the stimulus image and delivers it to the stimulus database 124, where the image is saved in file formats such as WEBP, PNG, and SVG for display alongside the associated mathematical question.

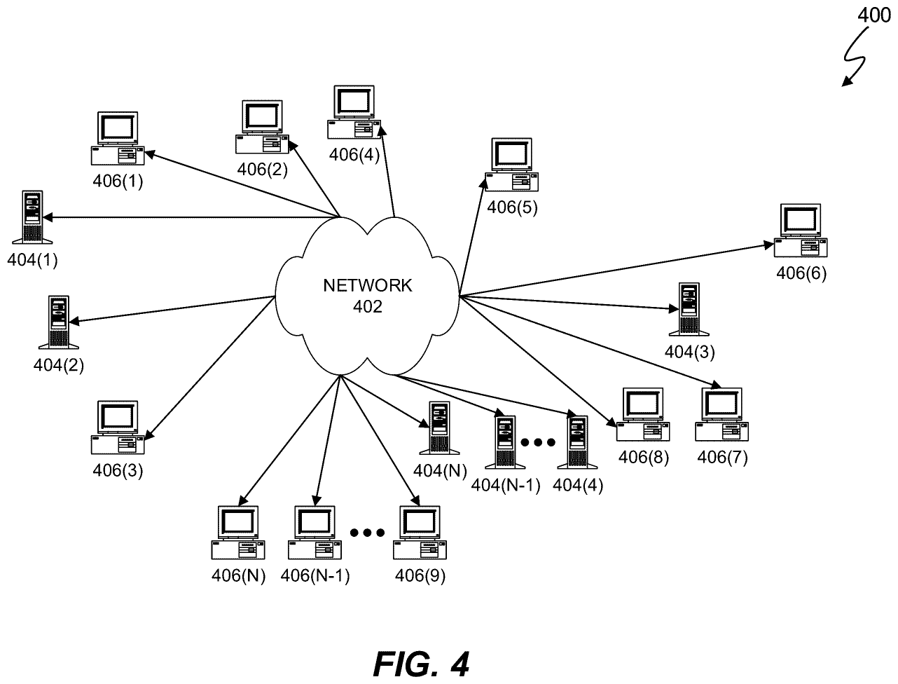

FIG. 4 is a block diagram illustrating a network environment 400 in which an exemplary stimulus image generation system 100 and stimulus image generation method 200 may be practiced. Network 402 (e.g. a private wide area network (WAN) or the Internet) includes a number of networked server computer systems 404(1)-(N) that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example communications channels providing T1 or OC3 service. Client computer systems 406(1)-(N) typically access server computer systems 404(1)-(N) through a service provider, such as an internet service provider (“ISP”) by executing application specific software, commonly referred to as a browser, on one of client computer systems 406(1)-(N).

Client computer systems 406(1)-(N) and/or server computer systems 404(1)-(N) are specialized computer programmed to improve conventional computer systems to implement and utilize the stimulus image generation system 100 and stimulus image generation method 200. The type of computer system that can be specially programmed to implement and utilize the stimulus image generation system 100 and stimulus image generation method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the stimulus image generation system 100 and stimulus image generation method 200 can be implemented using code stored in a tangible, non-transient computer readable medium and executed by one or more processors. In at least one embodiment, the stimulus image generation system 100 and stimulus image generation method 200 can be implemented completely in hardware using, for example, logic circuits and other circuits including field programmable gate arrays.

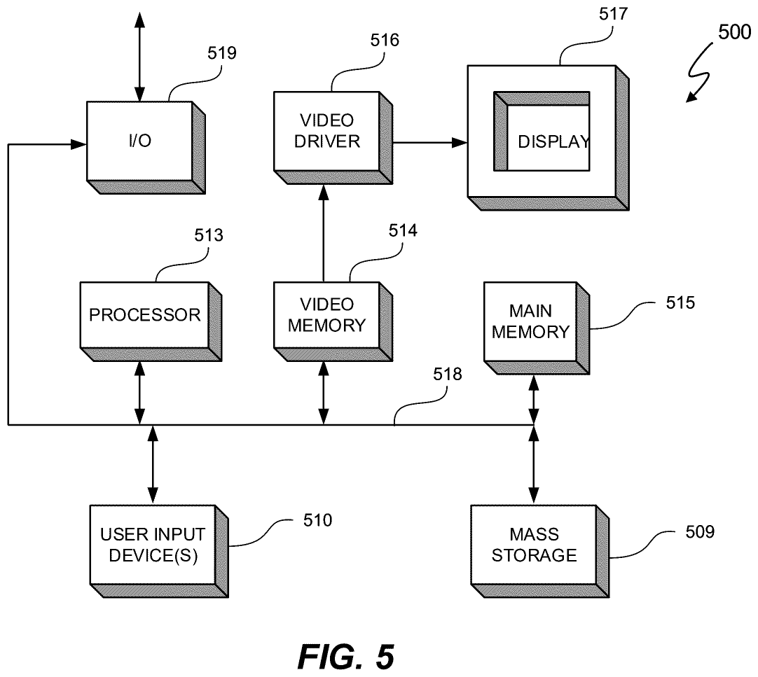

Embodiments of the stimulus image generation system 100 and stimulus image generation method 200 can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include both fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514 and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer systems via a telephone link or to the Internet via an ISP. I/O device(s) 519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 509, into main memory 515 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the display 517. Video amplifier 516 is well known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The stimulus image generation system 100 and stimulus image generation method 200 may be implemented in any type of computer system or programming or processing environment. It is contemplated that the stimulus image generation system 100 and stimulus image generation method 200 might be run on a stand-alone computer system, such as the one described above. The stimulus image generation system 100 and stimulus image generation method 200 might also be run from a server computer systems system that can be accessed by a plurality of client computer systems interconnected over an intranet network. Finally, the stimulus image generation system 100 and stimulus image generation method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding and constraining an AI engine to generate one or more stimulus images for mathematical questions based on an input query, the method comprises:
executing code using one or more processors of a computer system to cause the computer system to perform operations comprising:
providing access to a data model comprising educational standards and stimulus types, wherein the educational standards are mapped to one or more relevant stimulus types;
providing access to a repository of JSON schemas and Python functions, wherein each stimulus type is mapped to at least one JSON schema and one or more Python functions, thereby mapping the educational standards to relevant JSON schemas and Python functions;
selecting a relevant JSON schema and one or more Python functions based on the stimulus type of the received input query;
generating prompts to guide and constrain the AI engine to populate the selected JSON schema based on inputs received from the data model and input query, wherein the prompts include one or more functions for generating stimulus descriptions relevant to the mapped stimulus type;
transferring the prompts to the AI engine for populating the JSON schema;
calling one or more Python functions, via a Python function module, to generate a stimulus image, wherein the Python function module accesses one or more libraries for rendering the stimulus image;
storing the generated stimulus image in a stimulus database, wherein storing the stimulus image includes tagging the stimulus image to an associated mathematical question.

2. The method of claim 1, wherein the AI engine generates stimulus descriptions with relevant information related to the stimulus type.

3. The method of claim 2, wherein the AI engine utilizes a natural language processor (NLP) for extracting relevant information including numerical value, mathematical concepts, and contextual information.

4. The method of claim 1, wherein the Python function interprets the JSON schema to understand the stimulus description and uses libraries such as Mathplotlib to create the required stimulus image.

5. The method of claim 4, wherein the stimulus image includes one or more graphs, charts, coordinate planes, and number lines.

6. The method of claim 1, wherein the Python function saves the created stimulus image in an appropriate file format comprising WEBP, PNG, and SVG for display alongside the associated mathematical question.

7. The method of claim 1, wherein the method further comprises performing error handling and validation for the generated stimulus image via the Python function module.

8. The method of claim 1, wherein the JSON schema is a variable that serves as a general description of the stimulus type, and the description is used by the AI engine to populate the JSON schema for the stimulus type.

9. The method of claim 1 further comprises load-balancing techniques for the automated generation of stimulus images across the AI engine and Python function module.

10. The method of claim 1, wherein the AI engine includes one or more generative AI models including large language and foundational models.

11. A system of guiding and constraining an AI engine to generate one or more stimulus images for mathematical questions based on an input query, the system comprises:
one or more processors of a computer system;
a memory, coupled to the one or more processors, that stores code and execution of the code by the one or more processors causes the computer system to perform operations comprising:
providing access to a data model comprising educational standards and stimulus types, wherein the educational standards are mapped to one or more relevant stimulus types;
providing access to a repository of JSON schemas and Python functions, wherein each stimulus type is mapped to at least one JSON schema and one or more Python functions, thereby mapping the educational standards to relevant JSON schemas and Python functions;
selecting a relevant JSON schema and one or more Python functions based on the stimulus type of the received input query;
generating prompts to guide and constrain the AI engine to populate the selected JSON schema based on inputs received from the data model and input query, wherein the prompts include one or more functions for generating stimulus descriptions relevant to the mapped stimulus type;
transferring the prompts to the AI engine for populating the JSON schema;
calling one or more Python functions, via a Python function module, to generate a stimulus image, wherein the Python function module accesses one or more libraries for rendering the stimulus image;
storing the generated stimulus image in a stimulus database, wherein storing the stimulus image includes tagging the stimulus image to an associated mathematical question.

12. The system of claim 11, wherein the AI engine generates stimulus descriptions with relevant information related to the stimulus type.

13. The system of claim 12, wherein the AI engine utilizes a natural language processor (NLP) for extracting relevant information including numerical value, mathematical concepts, and contextual information.

14. The system of claim 11, wherein the Python function interprets the JSON schema to understand the stimulus description and uses libraries such as Mathplotlib to create the required stimulus image.

15. The system of claim 14, wherein the stimulus image includes one or more graphs, charts, coordinate planes, and number lines.

16. The system of claim 11, wherein the Python function saves the created stimulus image in an appropriate file format comprising WEBP, PNG, and SVG for display alongside the associated mathematical question.

17. The system of claim 11, wherein the method further comprises performing error handling and validation for the generated stimulus image via the Python function module.

18. The system of claim 11, wherein the JSON schema is a variable that serves as a general description of the stimulus type, and the description is used by the AI engine to populate the JSON schema for the stimulus type.

19. The system of claim 11 further comprises load-balancing techniques for the automated generation of stimulus images across the AI engine and Python function module.

20. The system of claim 11, wherein the AI engine includes one or more generative AI models including large language and foundational models.
